(19) United States
(12) Patent Application Publication
(10) Pub. No.: US 2013/0159825 A1
(43) Pub. Date: Jun. 20, 2013

(54) SEARCH RESULTS WITH MAPS

(71) Applicants: Kohki Nishio, Kawaguchi (JP); Tetsuaki Otsuki, Tokyo Prefecture (JP)

(72) Inventors: Kohki Nishio, Kawaguchi (JP); Tetsuaki Otsuki, Tokyo Prefecture (JP)

(73) Assignee: MICROSOFT CORPORATION, Redmond, WA (US)

(21) Appl. No.: 13/328,081

(22) Filed: Dec. 16, 2011

(51) Int. Cl. G06F 17/30; G06F 17/00

(52) U.S. Cl. 715/205; 707/722; 707/706; 707/E17.014; 707/E17.108

(57) ABSTRACT

A plurality of query responses is obtained based on a query. A corresponding selectable thumbnail map is determined for each query response, each corresponding selectable thumbnail map including a graphical geographic focus entity that is associated with the corresponding query response. A display of the query responses with the corresponding selectable thumbnail maps each displayed adjacent to its corresponding query response is initiated, in response to the query. A request for an expanded map is received based on a selection action associated with one of the corresponding selectable thumbnail maps. A display of the expanded map that includes a selectable link associated with the corresponding query response that is associated with the corresponding selectable thumbnail map that represents a compressed view of the expanded map is initiated, the expanded map displayed in a common display area with the display of the query responses with the corresponding selectable thumbnail maps.

### BACKGROUND

Users of electronic devices are increasingly relying on computerized services for many aspects of daily life. For example, users may rely on search results from web searches for making informed decisions regarding purchases, education, or travel plans. Many users may wish to search for particular items with a local intent. For example, a user may be hungry, and may wish to search for a particular type of restaurant on his/her mobile device, in hopes of obtaining results with regard to food vendors near a particular geographic location. As another example, a user may be traveling, and may wish to find hotel accommodations within walking distance of a particular train station.

### SUMMARY

According to one general aspect, a system may include a query response acquisition component that obtains a first plurality of query responses based on a first query. The system may also include a result geographic locality determination component that determines, via a device processor, corresponding result geographic localities associated with each of the first plurality of query responses. The system may also include a thumbnail map determination component that determines a corresponding selectable thumbnail map for each one of the first plurality of query responses, based on the corresponding result geographic localities, each of the corresponding selectable thumbnail maps including a graphical geographic focus entity indicating a geographic location that is associated with the corresponding one of the first plurality of query responses. The system may also include a query response transmission component that initiates transmission of query response display information associated with a display of each of the first plurality of query responses adjacent to each respective corresponding selectable thumbnail map. The system may also include an expanded map determination component that determines a first expanded map that corresponds to one of the selectable thumbnail maps, the first expanded map including a selectable link associated with the one of the first plurality of query responses that is associated with the one of the corresponding selectable thumbnail maps that represents a compressed view of the first expanded map. The system may also include an expanded map transmission component that initiates transmission of expanded map display information associated with a display of the first expanded map, in a display area in common with a display of at least a portion of the first plurality of query responses that includes the corresponding query response, the first expanded map including the selectable link associated with the corresponding query response that is associated with the one of the corresponding selectable thumbnail maps that represents a compressed view of the first expanded map.

According to another aspect, first query information associated with a first query may be obtained. A first plurality of query responses may be obtained based on the first query. A response geographic locality associated with each of the first plurality of query responses may be determined. A corresponding selectable thumbnail map may be obtained for each one of the first plurality of query responses, each of the corresponding selectable thumbnail maps including a graphical geographic focus entity that is associated with each one of the first plurality of query responses. A transmission of query response display information associated with a display of each of the first plurality of query responses adjacent to each respective corresponding selectable thumbnail map may be initiated. A first request for a first expanded map may be received based on a selection action associated with one of the corresponding selectable thumbnail maps. Transmission of expanded map display information associated with a display of the first expanded map, on a page in common with display of the corresponding query response may be initiated, the first expanded map including a selectable link associated with the corresponding query response that is associated with the one of the corresponding selectable thumbnail maps that represents a compressed view of the first expanded map.

According to another aspect, a computer program product tangibly embodied on a computer-readable storage medium may include executable code that may cause at least one data processing apparatus to obtain a first plurality of query responses based on a first query. Further, the at least one data processing apparatus may determine a corresponding selectable thumbnail map for each one of the first plurality of query responses, each of the corresponding selectable thumbnail maps including a graphical geographic focus entity that is associated with the corresponding one of the first plurality of query responses. Further, the at least one data processing apparatus may initiate a display of the first plurality of query responses with the corresponding selectable thumbnail maps each displayed adjacent to the corresponding one of the first plurality of query responses, in response to the first query. Further, the at least one data processing apparatus may receive a first request for a first expanded map based on a selection action associated with one of the corresponding selectable thumbnail maps. Further, the at least one data processing apparatus may initiate a display of the first expanded map that includes a selectable link associated with the corresponding one of the first plurality of query responses that is associated with the one of the corresponding selectable thumbnail maps that represents a compressed view of the first expanded map, the first expanded map displayed in a common display area with the display of the first plurality of query responses with the corresponding selectable thumbnail maps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for determining search results with maps.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

FIG. 5 depicts example user device displays of search results with maps.

FIG. 6 depicts example user device displays of search results with maps.

### DETAILED DESCRIPTION

Users of electronic devices may provide search queries with geo-local intent to a search engine, in hopes of obtaining search results that are focused on entities within a particular geographic area. For example, a traveler on a train may wish to search for hotel accommodations that may be close to his/her destination train station. Search results that are focused on hotels in another geographic area may not be helpful to the traveler. Many search results may provide names, addresses, and descriptions of hotel, but may involve drilling down several levels to determine a geographic location for a particular hotel, relative to the traveler's destination train station. Further, if the traveler is searching using a small mobile device, he/she may have difficulty manipulating maps and map icons in efforts to zoom in on a location for a particular hotel. Additionally, he/she may experience difficulty drilling down to information related to entities that may be associated with low relevance scores that may be assigned by a search engine.

Example techniques discussed herein may provide search results with selectable thumbnail maps for each search response, for queries with a geo-local intent. According to an example embodiment, each selectable thumbnail map may include a single graphical geographic focus icon indicating a relative location of an entity that is associated with the corresponding search result. According to an example embodiment, the selectable thumbnail maps may provide zoom features, so that a user may zoom in/out for various viewing perspectives.

According to an example embodiment, a selectable thumbnail map may be selected by a user (e.g., by clicking or touching the selectable thumbnail map) for a display of an expanded map that includes a larger version of the thumbnail map, with an expanded graphical geographic focus icon indicating a relative location of an entity that is associated with the corresponding search result. According to an example embodiment, the expanded map may include a selectable link and/or a caption corresponding to information included in the corresponding search result. According to an example embodiment, the expanded map may be displayed in a display area in common with a display of at least a portion of the search results that includes the corresponding search result (e.g., on a different layer of a common display window). According to an example embodiment, the expanded map may provide navigation controls, so that the user may move focal points to view different aspects of the geographic locality, and may further zoom in/out for various viewing perspectives.

For example, the zoom features may include a default zoom level specification for both the compressed and expanded map view, that may be based on one or more features associated with the target location. For example, features that may be used in determination of default and zoomed in levels may include one or more of an entity type (e.g., city, station, building, business entity), a size associated with an entity type (e.g., country, county, city, village), or a size associated with a primitive geometry of an entity (e.g., United State entity larger than United Kingdom entity, a football field larger than a building). For a three-dimensional (3-D) map implementation, a map view may specify a default zoom level (e.g., a scale) and a default view port that provides a desirable view of the 3-D map entity.

Thus, the user may quickly view each search result with its corresponding thumbnail map, make a decision to select a thumbnail map, and view and navigate an expanded map, without drilling down multiple levels or switching to map mode to request and view maps. Further, the user may select the selectable link on the expanded map, without minimizing the expanded map and navigating back to the originally displayed corresponding search result. According to an example embodiment, the user may scroll through the search results, and may view both results and their corresponding selectable thumbnail maps (for each result associated with a local intent query), for search results that may be associated with a low relevance score, without drilling down through multiple levels. Thus, search results with low relevance scores may receive more attention from users of the web searches.

Example techniques discussed herein may provide maps for search results that may include geographic location information, and thus may provide increased coverage over results obtained from phone book queries (e.g., phone book listings may involve registration of a business or entity with a phone book provider). Further, a user may wish to view maps, but may not know addresses of particular entities or locations when they are travelling, and wish to obtain search results while they are in transit.

According to an example embodiment, a map location may be determined from one or more addresses and/or spatial coordinates provided at a web page associated with a search response (e.g., a web page associated with a search response Uniform Resource Locator (URL)).

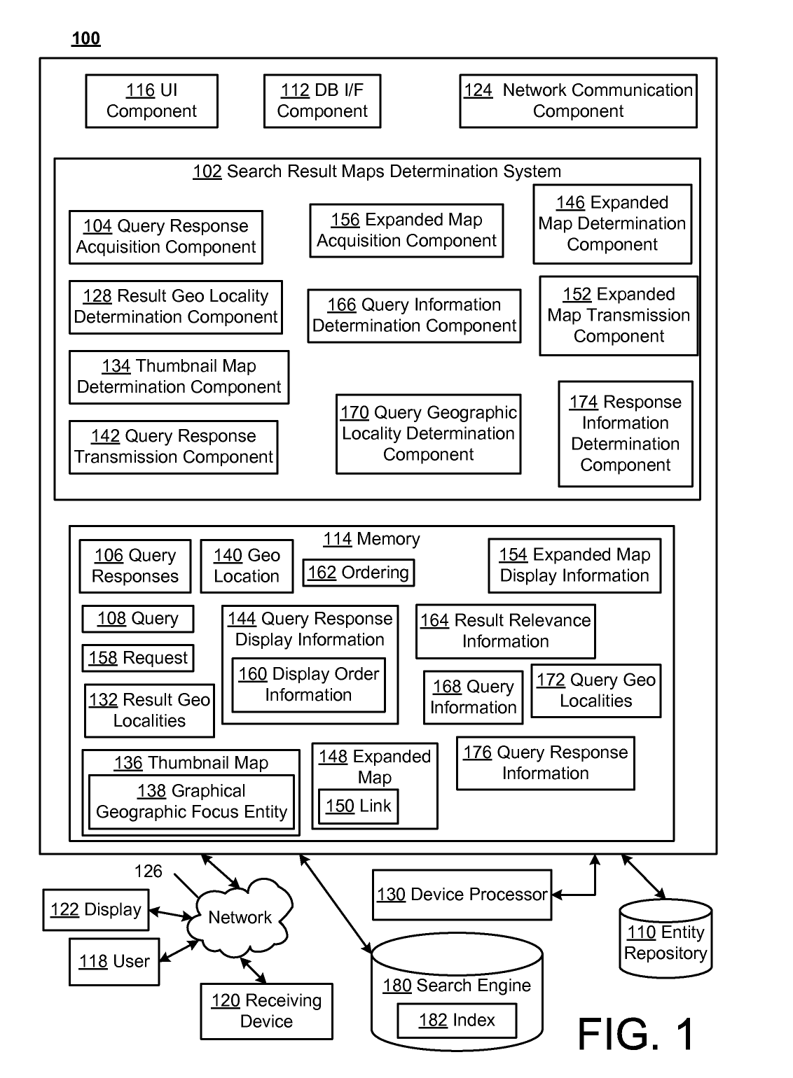

As further discussed herein, FIG. 1 is a block diagram of an example system 100 for determining search results with maps. As shown in FIG. 1, a system 100 may include a search result maps determination system 102 that includes a query response acquisition component 104 that may obtain a first plurality of query responses 106 based on a first query 108. For example, the query responses 106 may include web search results obtained in response to a query 108 submitted to a search engine. For example, the first query 108 may include a query associated with a local intent. For example, the first query 108 may include a street address or a name of a well-known establishment (e.g., a business name, building name, government entity name) or a name of a landmark (e.g., a bridge, a known geographic structure, a mountain, a battlefield). For example, the first query 108 may include a venue (e.g., a building name with a floor number, an underground area with a volume in space).

For example, the first query 108 may include an implicit query that includes a mention of a name of a business, organization, or venue, without specifying an address or spatial coordinates. For example, such queries may be processed based geo-location retrieval from a Global Positioning System (GPS), a reverse-IP (Internet Protocol address) lookup, a WiFi geo-location lookup, etc., that may associate the location with the query (e.g., a business name), retrieve the location information, and “alter” the query by adding the location information to it.

According to an example embodiment, the search result maps determination system 102 may include executable instructions that may be stored on a computer-readable storage medium, as discussed below. According to an example embodiment, the computer-readable storage medium may include any number of storage devices, and any number of storage media types, including distributed devices.

For example, an entity repository 110 may include one or more databases, and may be accessed via a database interface component 112. One skilled in the art of data processing will appreciate that there are many techniques for storing repository information discussed herein, such as various types of database configurations (e.g., SQL SERVERS) and non-database configurations.

According to an example embodiment, the search result maps determination system 102 may include a memory 114 that may store the first plurality of query responses 106. In this context, a “memory” may include a single memory device or multiple memory devices configured to store data and/or instructions. Further, the memory 114 may span multiple distributed storage devices.

According to an example embodiment, a user interface component 116 may manage communications between a user 118 and the search result maps determination system 102. The user 118 may be associated with a receiving device 120 that may be associated with a display 122 and other input/output devices. For example, the display 122 may be configured to communicate with the receiving device 120, via internal device bus communications, or via at least one network connection. For example, the display 122 may include a panel display, or it may include a three-dimensional (3-D) display (e.g., a 3-D projection). For example, an input device may include a keyboard or keypad, a touchscreen, tactile sensors, haptic sensors, image input devices, and/or an audio input device. For example, input may include user gestures that may be detected via one or more image sensors. For example, audio input may include voice commands.

According to an example embodiment, the search result maps determination system 102 may include a network communication component 124 that may manage network communication between the search result maps determination system 102 and other entities that may communicate with the search result maps determination system 102 via at least one network 126. For example, the at least one network 126 may include at least one of the Internet, at least one wireless network, or at least one wired network. For example, the at least one network 126 may include a cellular network, a radio network, or any type of network that may support transmission of data for the search result maps determination system 102. For example, the network communication component 124 may manage network communications between the search result maps determination system 102 and the receiving device 120. For example, the network communication component 124 may manage network communication between the user interface component 116 and the user 118, or between the user interface component 116 and the receiving device 120.

A result geographic locality determination component 128 may determine, via a device processor 130, corresponding result geographic localities 132 associated with each of the first plurality of query responses 106. For example, the corresponding result geographic localities 132 may be determined based on an analysis of content of web pages associated with the query results 106. For example, the corresponding result geographic localities 132 may be determined based on spatial data associated with the query results 106 that may be stored in a database associated with a search engine. For example, the corresponding result geographic localities 132 may include one or more bounded geographic areas. For example, the corresponding result geographic localities 132 may include one or more venues (e.g., a building name with a floor number, an underground area with a volume in space).

In this context, a “processor” may include a single processor or multiple processors configured to process instructions associated with a processing system. A processor may thus include multiple processors processing instructions in parallel and/or in a distributed manner. Although the device processor 130 is depicted as external to the search result maps determination system 102 in FIG. 1, one skilled in the art of data processing will appreciate that the device processor 130 may be implemented as a single component, and/or as distributed units which may be located internally or externally to the search result maps determination system 102, and/or any of its elements.

A thumbnail map determination component 134 may determine a corresponding selectable thumbnail map 136 for each one of the first plurality of query responses 106, based on the corresponding result geographic localities 132, each of the corresponding selectable thumbnail maps 136 including a graphical geographic focus entity 138 indicating a geographic location 140 that is associated with the corresponding one of the first plurality of query responses 106. For example, the graphical geographic focus entity 138 may include a graphical icon that may indicate a geographic location in the selectable thumbnail map 136 of an entity that is associated with the corresponding query response 106. For example, each of the corresponding selectable thumbnail maps 136 may include a single graphical geographic focus entity 138 indicating a location of an entity associated with the corresponding query response 106.

A query response transmission component 142 may initiate transmission of query response display information 144 associated with a display of each of the first plurality of query responses 106 adjacent to each respective corresponding selectable thumbnail map 136. For example, a server may send the query response display information 144 to a user device (e.g., the receiving device 120) for display on a display device (e.g., the display 122). For example, the display may include a two-dimensional (2-D) display or a 3-D display, as discussed further herein.

An expanded map determination component 146 may determine a first expanded map 148 that corresponds to one of the selectable thumbnail maps 136, the first expanded map 148 including a selectable link 150 associated with the one of the first plurality of query responses 106 that is associated with the one of the corresponding selectable thumbnail maps 136 that represents a compressed view of the first expanded map 148. For example, the expanded map 148 may include a larger, more detailed view of its corresponding selectable thumbnail map 136.

An expanded map transmission component 152 may initiate transmission of expanded map display information 154 associated with a display of the first expanded map 148, in a display area in common with a display of at least a portion of the first plurality of query responses 106 that includes the corresponding query response, the first expanded map 148 including the selectable link 150 associated with the corresponding query response 106 that is associated with the one of the corresponding selectable thumbnail maps 136 that represents a compressed view of the first expanded map 148. For example, the expanded map display information 154 may include display information for display of the first expanded map 148 in a common display window with at least a portion of the query responses 106 that includes the query response 106 corresponding to a selected thumbnail map 136.

According to an example embodiment, an expanded map acquisition component 156 may receive a first request 158 for the first expanded map 148 based on a selection action associated with one of the corresponding selectable thumbnail maps 136. For example, the selection action may include a click or user touch on a desired selectable thumbnail map 136. For example, the selection action may include a user gesture or a user utterance. For example, a user device may send the first request 158 in response to the selection action.

According to an example embodiment, the expanded map transmission component 152 may initiate transmission of the expanded map display information 154 in response to the first request 158 for the first expanded map 148.

According to an example embodiment, the query response display information 144 may include display order information 160 associated with an ordering 162 of the display of each of the first plurality of query responses 106 adjacent to each respective corresponding selectable thumbnail map 136, the display order information 160 based on search engine result relevance information 164. For example, a search engine may provide ranking values associated with relevance scores associated with each of the query responses 106. For example, the ordering 162 may be determined based on relevance scores, or other ordering information provided by a search engine with the query responses 106.

According to an example embodiment, the first plurality of query responses 106 may include one or more of an aggregated query response that includes aggregated query response data based on a search response aggregation operation associated with a search engine, a Uniform Resource Locator (URL) associated with a first web page representing a first one of the plurality of query responses 106, a caption and a URL associated with a second web page representing a second one of the plurality of query responses 106, or a web page description associated with a third web page representing a third one of the plurality of query responses 106.

According to an example embodiment, a query information determination component 166 may obtain first query information 168 associated with the first query 108. For example, the first query information 168 may include a street address included in the first query 108. For example, the first query information 168 may include a name of a landmark (e.g., a bridge, a known geographic structure, a mountain, a battlefield) or known establishment (e.g., a business name, building name, government entity name) included in the first query 108. For example, the first query information 168 may include a venue (e.g., a building name with a floor number, an underground area with a volume in space). For example, the first query information 168 may include a location associated with a user providing the query 108 (e.g., Global Positioning System (GPS) coordinates, user-provided location information, Internet Protocol (IP) address associated with user query).

According to an example embodiment, a query geographic locality determination component 170 may determine one or more query geographic localities 172 associated with the first query 108, based on the first query information 168.

According to an example embodiment, the thumbnail map determination component 134 may determine at least one of the corresponding selectable thumbnail maps 136 based on the one or more query geographic localities 172 associated with the first query 108. For example, a corresponding selectable thumbnail maps 136 may be determined if the query 108 includes local intent information associated with a geographic locality.

According to an example embodiment, the first query information 168 may include one or more of a street address, an indication of a geographic location, a geographic location indication associated with a user device that is associated with a transmission of the first query 108, an indication of a landmark, or a name of an item. For example, the indication of a geographic location may include a venue or a term known to reference a particular geographic location. For example, the indication of a geographic location may include a label associated with a particular geographic location or venue (e.g., “alpha's beta trap” to indicate a popular geographic venue or gathering location). For example, the name of an item may include a name of an entity that is associated with one or more geographic locations.

According to an example embodiment, a response information determination component 174 may obtain corresponding query response information 176 associated with each one of the first plurality of query responses 106.

According to an example embodiment, the thumbnail map determination component 134 may determine at least one of the corresponding selectable thumbnail maps 136 based on the corresponding query response information 176 associated with at least one of the first plurality of query responses 106. For example, the corresponding query response information 176 may include information derived from web pages associated with the query responses 106, or may include information provided by a search engine that provides the query response 106.

According to an example embodiment, the corresponding query response information 176 may include one or more of geographic location information included in a query response web page, geographic location information included in web page metadata associated with a query response web page, a street address, an indication of a geographic location, an indication of a landmark, or a name of an item.

A search engine 180 may be used for obtaining search results. According to an example embodiment, the search engine 180 may include an index 182 for increased search efficiency. For example, the index 182 may include spatial data so that geographic localities may be determined during a search without scanning every web page included in search results. For example, if a web page includes spatial data such as GPS coordinates, latitude/longitude data, or an address, the spatial data may be stored in the index 182 for swift lookup in a search. According to an example embodiment, the corresponding query response information 176 may be derived from the index 182 associated with the search engine 180.

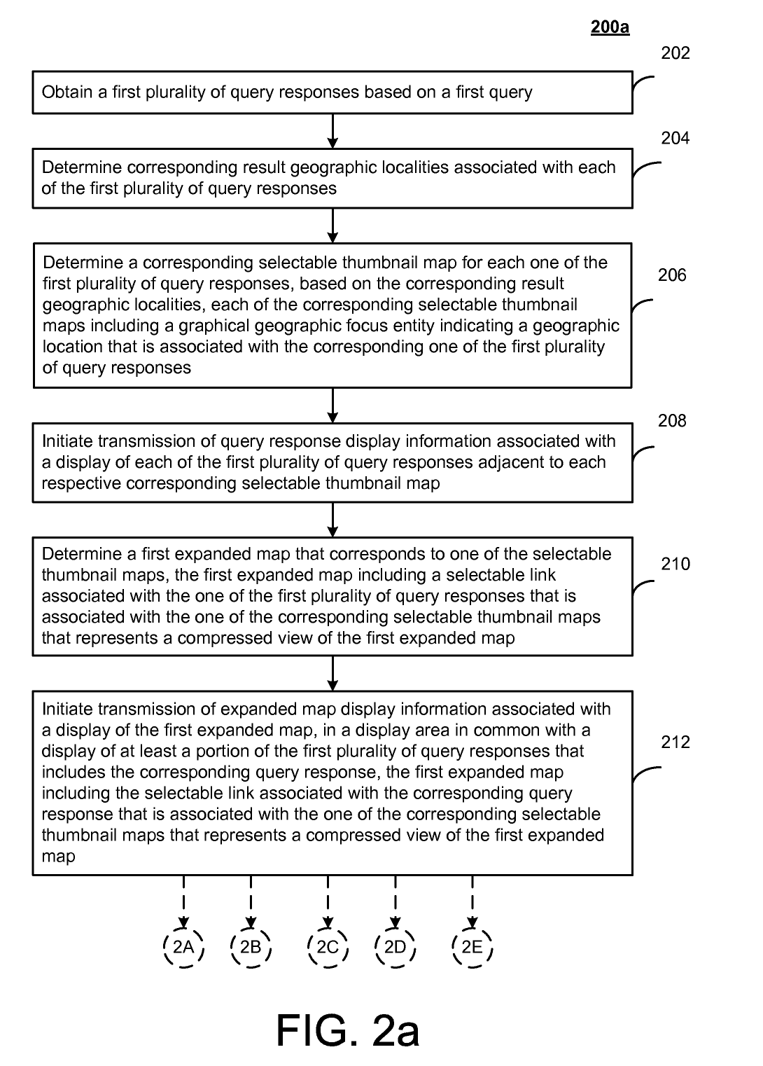

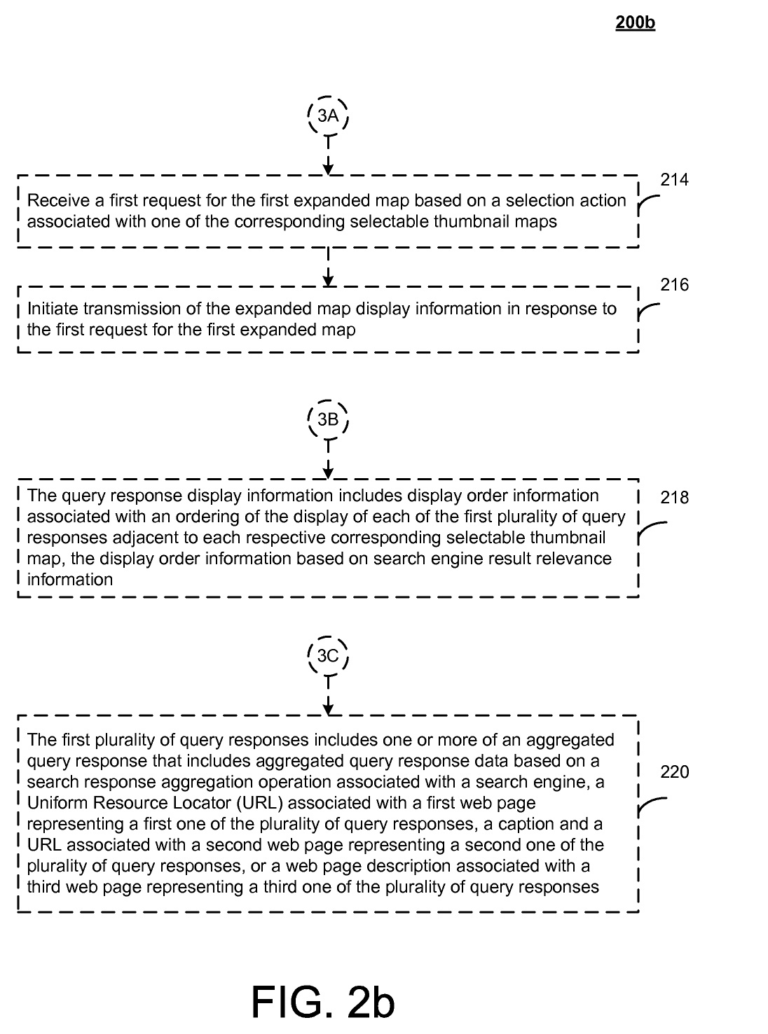

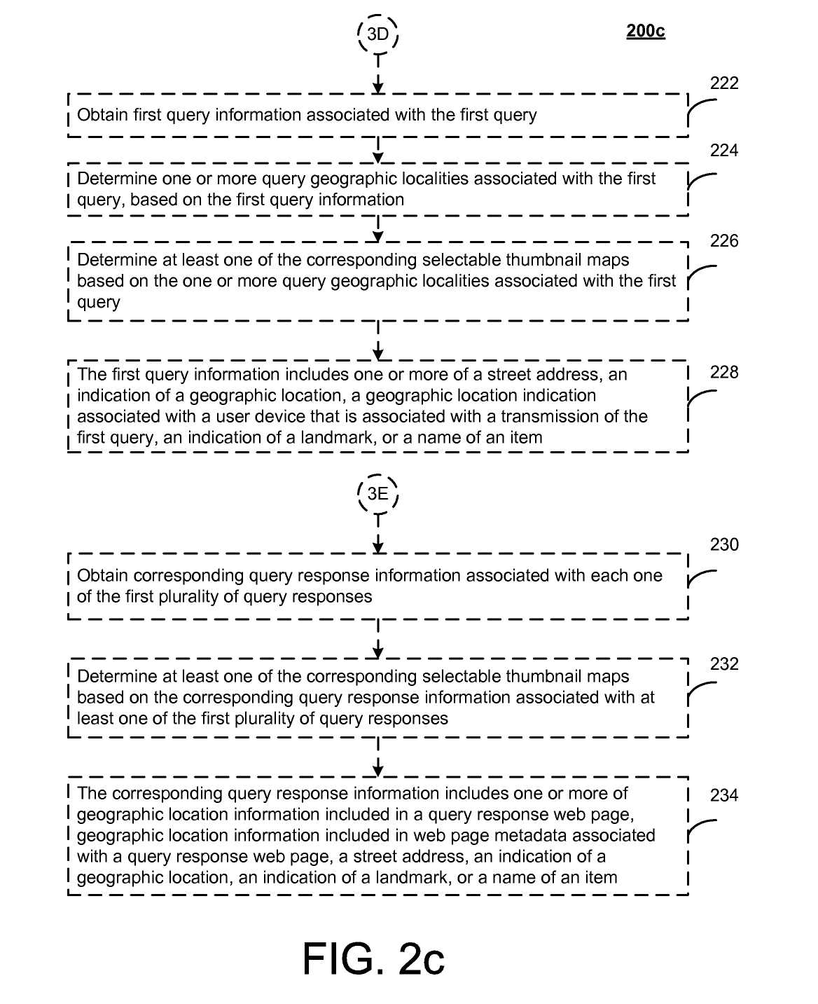

FIG. 2 is a flowchart illustrating example operations of the system of FIG. 1, according to example embodiments. In the example of FIG. 2a, a first plurality of query responses may be obtained, based on a first query (202). For example, the query response acquisition component 104 may obtain the first plurality of query responses 106 based on the first query 108, as discussed above.

Corresponding result geographic localities associated with each of the first plurality of query responses may be determined (204). For example, the result geographic locality determination component 128 may determine, via the device processor 130, the corresponding result geographic localities 132 associated with each of the first plurality of query responses 106, as discussed above.

A corresponding selectable thumbnail map may be determined for each one of the first plurality of query responses, based on the corresponding result geographic localities, each of the corresponding selectable thumbnail maps including a graphical geographic focus entity indicating a geographic location that is associated with the corresponding one of the first plurality of query responses (206). For example, the thumbnail map determination component 134 may determine a corresponding selectable thumbnail map 136 for each one of the first plurality of query responses 106, based on the corresponding result geographic localities 132, each of the corresponding selectable thumbnail maps 136 including a graphical geographic focus entity 138 indicating a geographic location 140 that is associated with the corresponding one of the first plurality of query responses 106, as discussed above.

Transmission of query response display information associated with a display of each of the first plurality of query responses adjacent to each respective corresponding selectable thumbnail map may be initiated (208). For example, the query response transmission component 142 may initiate transmission of query response display information 144 associated with a display of each of the first plurality of query responses 106 adjacent to each respective corresponding selectable thumbnail map 136, as discussed above. For example, the display information may be configured to provide a display on a panel, or via other types of display techniques. For example, the information may be configured to provide a display via a headset, or via a projected image or display. For example, inputs associated with such displays may include user gestures, audio input, keyboard or touchpad input, and/or input via virtual or optical keyboards. Inputs and/or outputs may also be accomplished via sensory devices.

A first expanded map that corresponds to one of the selectable thumbnail maps may be determined, the first expanded map including a selectable link associated with the one of the first plurality of query responses that is associated with the one of the corresponding selectable thumbnail maps that represents a compressed view of the first expanded map (210). For example, the expanded map determination component 146 may determine a first expanded map 148 that corresponds to one of the selectable thumbnail maps 136, the first expanded map 148 including a selectable link 150 associated with the one of the first plurality of query responses 106 that is associated with the one of the corresponding selectable thumbnail maps 136 that represents a compressed view of the first expanded map 148, as discussed above.

Transmission of expanded map display information associated with a display of the first expanded map, in a display area in common with a display of at least a portion of the first plurality of query responses that includes the corresponding query response may be initiated, the first expanded map including the selectable link associated with the corresponding query response that is associated with the one of the corresponding selectable thumbnail maps that represents a compressed view of the first expanded map (212). For example, the expanded map transmission component 152 may initiate transmission of expanded map display information 154 associated with a display of the first expanded map 148, in a display area in common with a display of at least a portion of the first plurality of query responses 106 that includes the corresponding query response, the first expanded map 148 including the selectable link 150 associated with the corresponding query response 106 that is associated with the one of the corresponding selectable thumbnail maps 136 that represents a compressed view of the first expanded map 148, as discussed above.

According to an example embodiment, a first request for the first expanded map may be received based on a selection action associated with one of the corresponding selectable thumbnail maps (214). For example, the expanded map acquisition component 156 may receive a first request 158 for the first expanded map 148 based on a selection action associated with one of the corresponding selectable thumbnail maps 136, as discussed above.

According to an example embodiment, transmission of the expanded map display information may be initiated in response to the first request for the first expanded map (216). For example, the expanded map transmission component 152 may initiate transmission of the expanded map display information 154 in response to the first request 158 for the first expanded map 148, as discussed above.

According to an example embodiment, the query response display information 144 may include display order information 160 associated with an ordering 162 of the display of each of the first plurality of query responses 106 adjacent to each respective corresponding selectable thumbnail map 136, the display order information 160 based on search engine result relevance information 164 (218).

According to an example embodiment, the first plurality of query responses 106 may include one or more of an aggregated query response that includes aggregated query response data based on a search response aggregation operation associated with a search engine, a Uniform Resource Locator (URL) associated with a first web page representing a first one of the plurality of query responses 106, a caption and a URL associated with a second web page representing a second one of the plurality of query responses 106, or a web page description associated with a third web page representing a third one of the plurality of query responses 106 (220).

According to an example embodiment, first query information associated with the first query may be obtained (222). For example, the query information determination component 166 may obtain first query information 168 associated with the first query 108, as discussed above.

According to an example embodiment, one or more query geographic localities associated with the first query may be determined, based on the first query information (224). For example, the query geographic locality determination component 170 may determine one or more query geographic localities 172 associated with the first query 108, based on the first query information 168, as discussed above.

According to an example embodiment, at least one of the corresponding selectable thumbnail maps may be determined based on the one or more query geographic localities associated with the first query (226). For example, the thumbnail map determination component 134 may determine at least one of the corresponding selectable thumbnail maps 136 based on the one or more query geographic localities 172 associated with the first query 108, as discussed above.

According to an example embodiment, the first query information 168 may include one or more of a street address, an indication of a geographic location, a geographic location indication associated with a user device that is associated with a transmission of the first query 108, an indication of a landmark, or a name of an item (228).

According to an example embodiment, corresponding query response information associated with each one of the first plurality of query responses may be obtained (230). For example, the response information determination component 174 may obtain corresponding query response information 176 associated with each one of the first plurality of query responses 106, as discussed above.

According to an example embodiment, at least one of the corresponding selectable thumbnail maps may be determined based on the corresponding query response information associated with at least one of the first plurality of query responses (232). For example, the thumbnail map determination component 134 may determine at least one of the corresponding selectable thumbnail maps 136 based on the corresponding query response information 176 associated with at least one of the first plurality of query responses 106, as discussed above.

According to an example embodiment, the corresponding query response information 176 may include one or more of geographic location information included in a query response web page, geographic location information included in web page metadata associated with a query response web page, a street address, an indication of a geographic location, an indication of a landmark, or a name of an item (234).

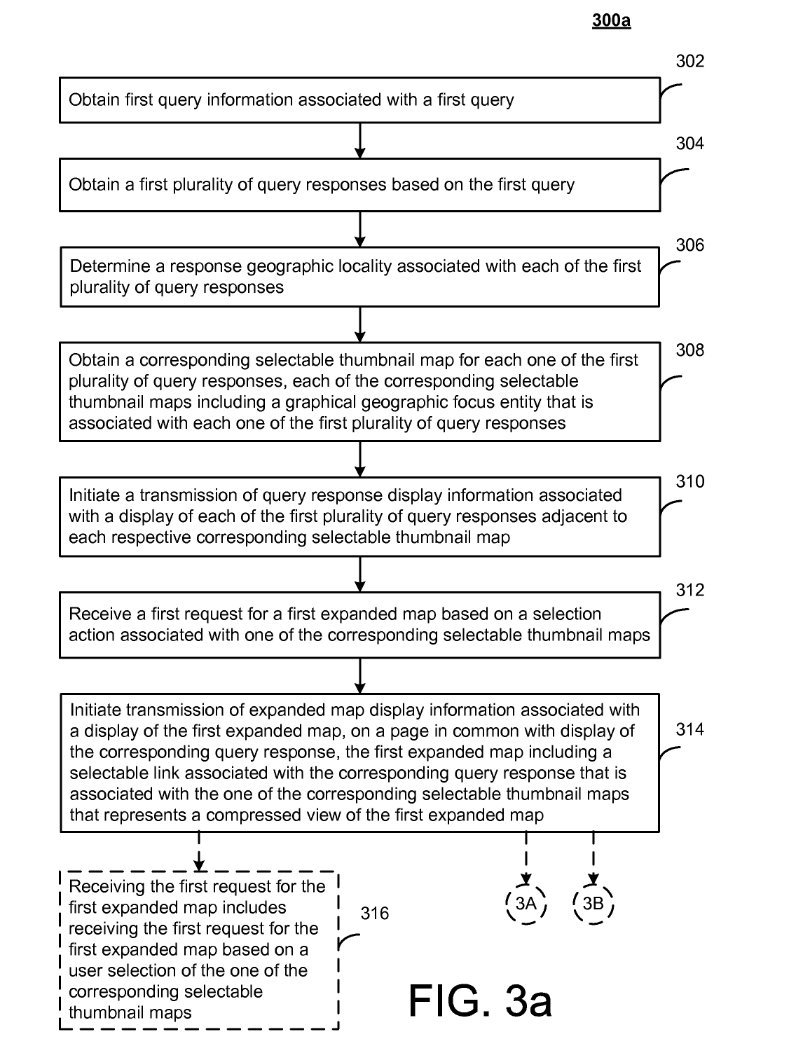

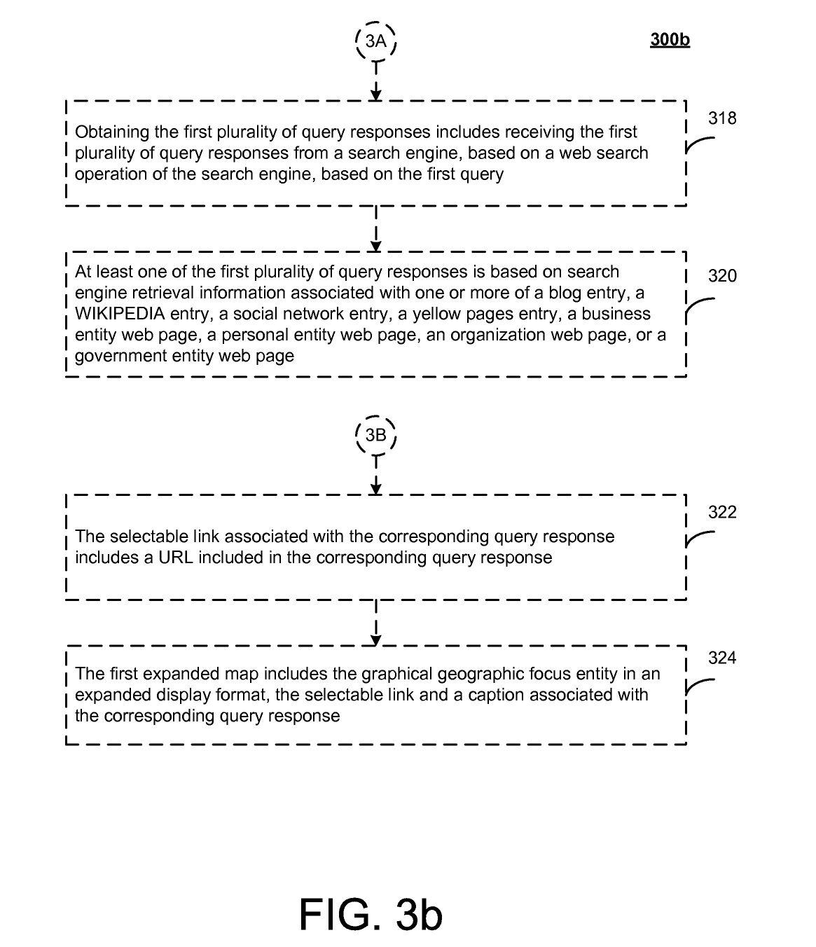

FIG. 3 is a flowchart illustrating example operations associated with the system of FIG. 1, according to example embodiments. In the example of FIG. 3, first query information associated with a first query may be obtained (302). For example, the query information determination component 166 may obtain first query information 168 associated with the first query 108, as discussed above.

A first plurality of query responses may be obtained based on the first query (304). For example, the query response acquisition component 104 may obtain the first plurality of query responses 106 based on the first query 108, as discussed above.

A response geographic locality associated with each of the first plurality of query responses may be determined (306). For example, the result geographic locality determination component 128 may determine, via the device processor 130, the corresponding result geographic localities 132 associated with each of the first plurality of query responses 106, as discussed above.

A corresponding selectable thumbnail map may be obtained for each one of the first plurality of query responses, each of the corresponding selectable thumbnail maps including a graphical geographic focus entity that is associated with each one of the first plurality of query responses (308). For example, the thumbnail map determination component 134 may determine a corresponding selectable thumbnail map 136 for each one of the first plurality of query responses 106, as discussed above.

A transmission of query response display information associated with a display of each of the first plurality of query responses adjacent to each respective corresponding selectable thumbnail map may be initiated (310). For example, the query response transmission component 142 may initiate transmission of query response display information 144 associated with a display of each of the first plurality of query responses 106 adjacent to each respective corresponding selectable thumbnail map 136, as discussed above.

A first request for a first expanded map may be received based on a selection action associated with one of the corresponding selectable thumbnail maps (312). For example, the expanded map acquisition component 156 may receive a first request 158 for the first expanded map 148 based on a selection action associated with one of the corresponding selectable thumbnail maps 136, as discussed above.

Transmission of expanded map display information associated with a display of the first expanded map, on a page in common with display of the corresponding query response may be initiated, the first expanded map including a selectable link associated with the corresponding query response that is associated with the one of the corresponding selectable thumbnail maps that represents a compressed view of the first expanded map (314). For example, the expanded map transmission component 152 may initiate transmission of expanded map display information 154 associated with a display of the first expanded map 148, in a display area in common with a display of at least a portion of the first plurality of query responses 106 that includes the corresponding query response, the first expanded map 148 including the selectable link 150 associated with the corresponding query response 106 that is associated with the one of the corresponding selectable thumbnail maps 136 that represents a compressed view of the first expanded map 148, as discussed above.

According to an example embodiment, receiving the first request for the first expanded map may include receiving the first request for the first expanded map based on a user selection of the one of the corresponding selectable thumbnail maps (316).

According to an example embodiment, obtaining the first plurality of query responses may include receiving the first plurality of query responses from a search engine, based on a web search operation of the search engine, based on the first query (318).

According to an example embodiment, at least one of the first plurality of query responses is based on search engine retrieval information associated with one or more of a blog entry, a WIKIPEDIA entry, a social network entry, a yellow pages entry, a business entity web page, a personal entity web page, an organization web page, or a government entity web page (320). For example, a business entity web page may include a corporate web page, a for-profit or non-profit business entity web page, or any other type of web page associated with a business. For example, an organization web page may include a web page associated with a club, society, or any other type of organization (e.g., non-governmental organizations, non-profit organizations).

According to an example embodiment, the selectable link associated with the corresponding query response may include a URL included in the corresponding query response (322).

According to an example embodiment, the first expanded map may include the graphical geographic focus entity in an expanded display format, the selectable link and a caption associated with the corresponding query response (324).

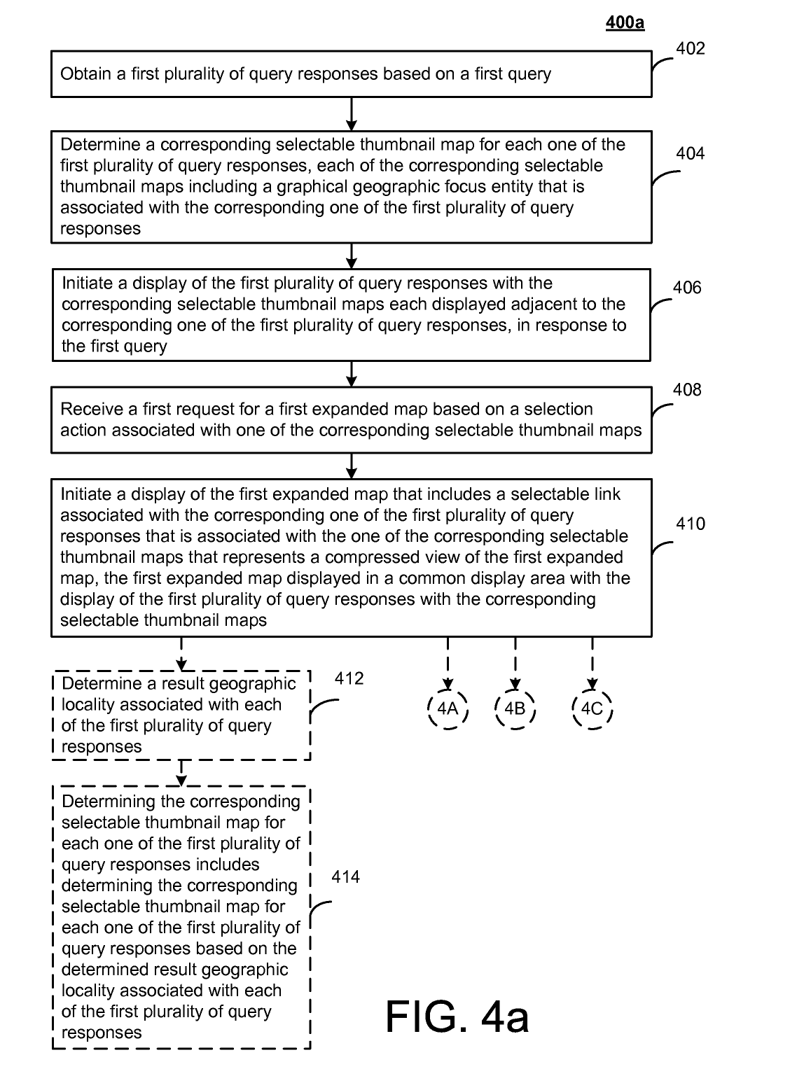

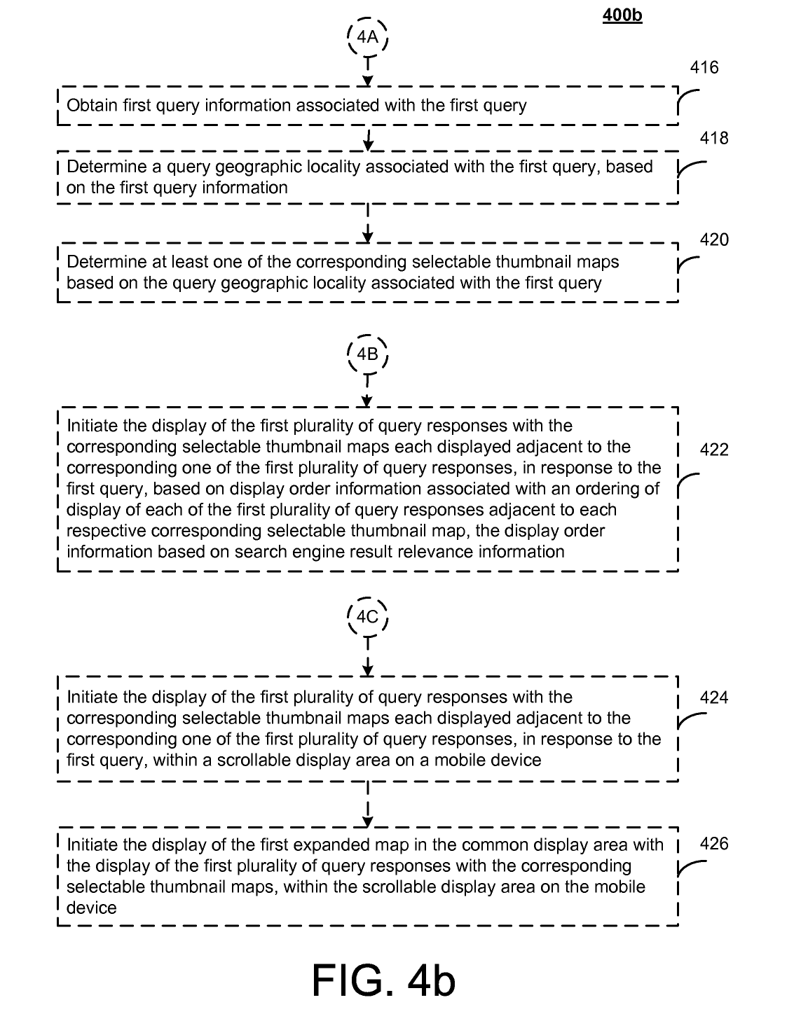

FIG. 4 is a flowchart illustrating example operations of a device with the system of FIG. 1, according to example embodiments. For example, the device may include the receiving device 120 of FIG. 1. In the example of FIG. 4, a first plurality of query responses may be obtained based on a first query (402). For example, the query response acquisition component 104 may obtain the first plurality of query responses 106 based on the first query 108, as discussed above.

A corresponding selectable thumbnail map may be determined for each one of the first plurality of query responses, each of the corresponding selectable thumbnail maps including a graphical geographic focus entity that is associated with the corresponding one of the first plurality of query responses (404). For example, the thumbnail map determination component 134 may determine a corresponding selectable thumbnail map 136 for each one of the first plurality of query responses 106, as discussed above.

A display of the first plurality of query responses with the corresponding selectable thumbnail maps each displayed adjacent to the corresponding one of the first plurality of query responses may be initiated, in response to the first query (406). For example, the query response transmission component 142 may initiate transmission of query response display information 144 associated with a display of each of the first plurality of query responses 106 adjacent to each respective corresponding selectable thumbnail map 136, as discussed above.

A first request for a first expanded map may be received based on a selection action associated with one of the corresponding selectable thumbnail maps (408). For example, the expanded map acquisition component 156 may receive a first request 158 for the first expanded map 148 based on a selection action associated with one of the corresponding selectable thumbnail maps 136, as discussed above.

A display of the first expanded map that includes a selectable link associated with the corresponding one of the first plurality of query responses that is associated with the one of the corresponding selectable thumbnail maps that represents a compressed view of the first expanded map may be initiated, the first expanded map displayed in a common display area with the display of the first plurality of query responses with the corresponding selectable thumbnail maps (410). For example, the expanded map transmission component 152 may initiate transmission of expanded map display information 154 associated with a display of the first expanded map 148, in a display area in common with a display of at least a portion of the first plurality of query responses 106 that includes the corresponding query response, the first expanded map 148 including the selectable link 150 associated with the corresponding query response 106 that is associated with the one of the corresponding selectable thumbnail maps 136 that represents a compressed view of the first expanded map 148, as discussed above.

According to an example embodiment, a result geographic locality associated with each of the first plurality of query responses may be determined (412). For example, the result geographic locality determination component 128 may determine, via the device processor 130, the corresponding result geographic localities 132 associated with each of the first plurality of query responses 106, as discussed above.

According to an example embodiment, determining the corresponding selectable thumbnail map for each one of the first plurality of query responses may include determining the corresponding selectable thumbnail map for each one of the first plurality of query responses based on the determined result geographic locality associated with each of the first plurality of query responses (414). For example, the thumbnail map determination component 134 may determine the corresponding selectable thumbnail map 136 for each one of the first plurality of query responses 106, based on the corresponding result geographic localities 132, as discussed above.

According to an example embodiment, first query information associated with the first query may be obtained (416). For example, the query information determination component 166 may obtain first query information 168 associated with the first query 108, as discussed above.

According to an example embodiment, a query geographic locality associated with the first query may be determined, based on the first query information (418). For example, the query geographic locality determination component 170 may determine one or more query geographic localities 172 associated with the first query 108, based on the first query information 168, as discussed above.

According to an example embodiment, at least one of the corresponding selectable thumbnail maps may be determined based on the query geographic locality associated with the first query (420). For example, the thumbnail map determination component 134 may determine at least one of the corresponding selectable thumbnail maps 136 based on the one or more query geographic localities 172 associated with the first query 108, as discussed above.

According to an example embodiment, the display of the first plurality of query responses with the corresponding selectable thumbnail maps each displayed adjacent to the corresponding one of the first plurality of query responses may be initiated, in response to the first query, based on display order information associated with an ordering of display of each of the first plurality of query responses adjacent to each respective corresponding selectable thumbnail map, the display order information based on search engine result relevance information (422).

According to an example embodiment, the display of the first plurality of query responses with the corresponding selectable thumbnail maps each displayed adjacent to the corresponding one of the first plurality of query responses may be initiated, in response to the first query, within a scrollable display area on a mobile device (424). For example, the mobile device may include a mobile phone, a tablet, a personal computer, a personal digital assistant, or any other type of mobile device (e.g., a device built into a vehicle).

According to an example embodiment, the display of the first expanded map may be initiated, in the common display area with the display of the first plurality of query responses with the corresponding selectable thumbnail maps, within the scrollable display area on the mobile device (426).

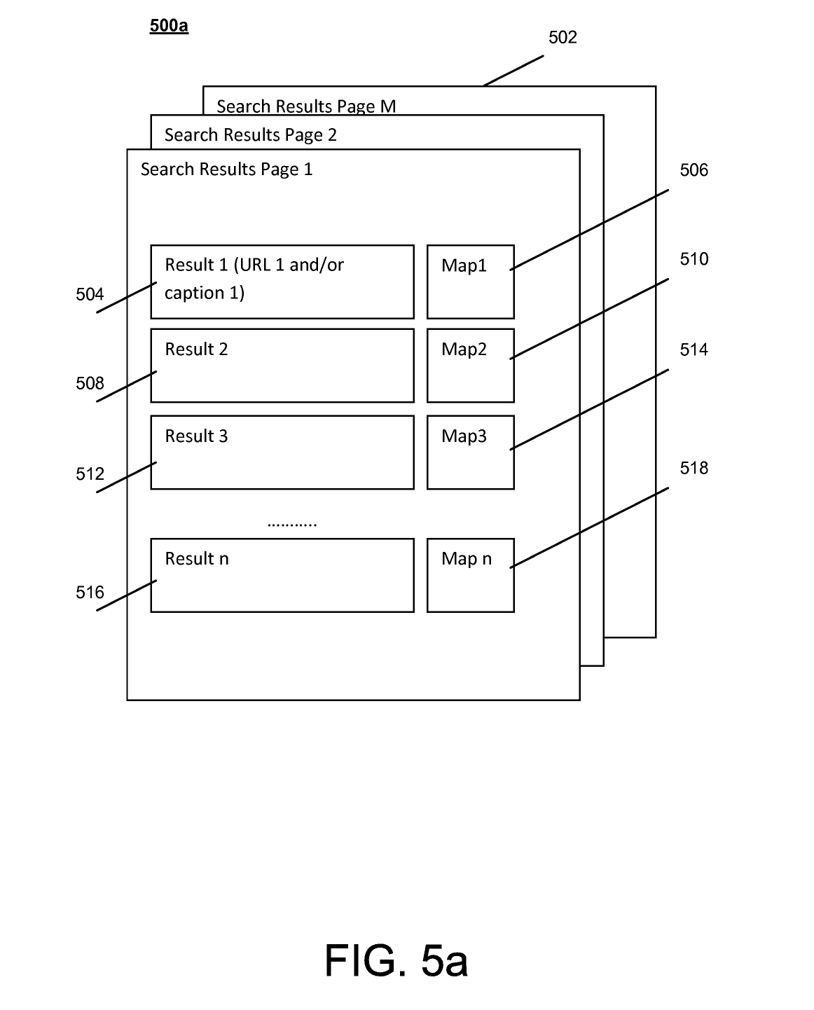

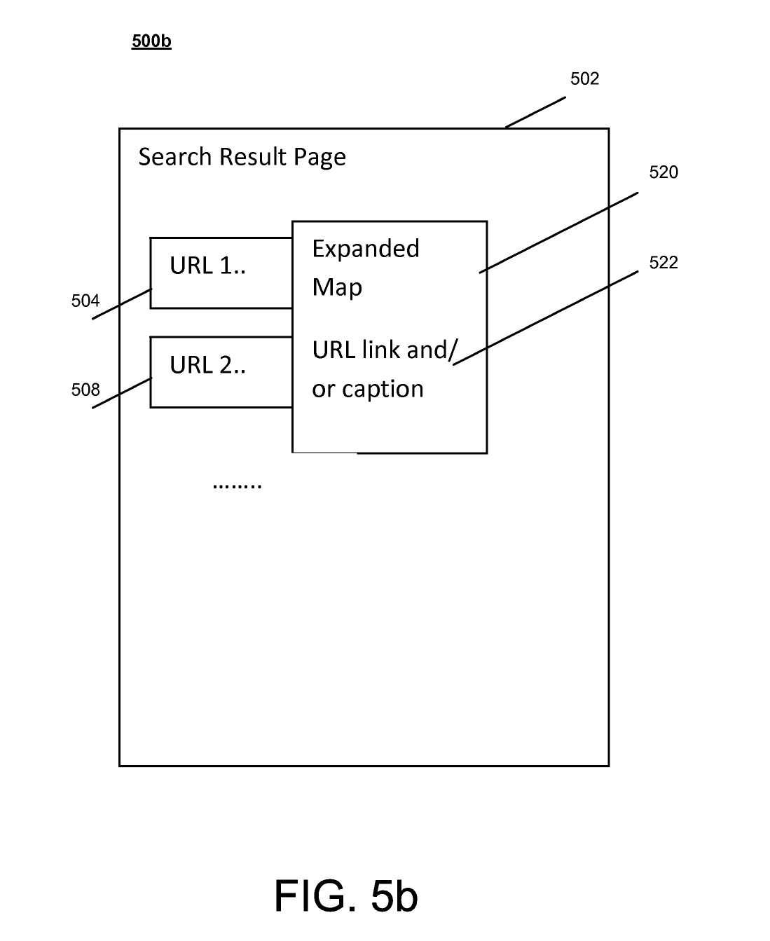

FIG. 5 depicts example user device displays of search results with maps, in accordance with example embodiments discussed herein. As shown in FIG. 5a, search results pages 502 may include a plurality of search results with corresponding selectable thumbnail maps. For example, a first search result 504 (e.g., a query response 106) may be displayed adjacent to a selectable thumbnail map 506 that is associated with the first search result 504. Similarly, a search result 508 may be displayed adjacent to a selectable thumbnail map 510 that is associated with the search result 508, a search result 512 may be displayed adjacent to a selectable thumbnail map 514 that is associated with the search result 512, and a search result 516 may be displayed adjacent to a selectable thumbnail map 518 that is associated with the search result 516.

As shown in FIG. 5b, an expanded map 520 may be displayed in response to a user selection of one of the selectable thumbnail maps 506, 510, 514, or 518 shown in FIG. 5a. As shown in FIG. 5b, the expanded map 520 may include a selectable link 522 (e.g., the expanded map 520 may include a URL link and/or a caption). According to an example embodiment, when the user selects the selectable thumbnail map (e.g., via a click or touch on the thumbnail map), a bigger map may appear on the same page which may be displayed at a different layer. According to example embodiments, the expanded map 520 may be movable or immobile. According to example embodiments, the expanded map 520 may be closed, and/or may include a link to a corresponding URL which may allow page jumps. According to an example embodiment, the expanded map 520 may include map control (e.g., map navigation, zoom controls). According to example embodiments, the expanded map 520 may include a “directions” search link to provide a direct link to obtain directions for navigation to a particular entity.

For an example viewport of a 3-D environment (e.g., the maps discussed herein, based on 3-D implementation) using a spherical coordinate system, controls may include a control based on the radial distance from the origin (e.g., similar to 2-D zoom control), an azimuthal angular control (e.g., control based on directions such as north, south, east, west, and angles in between, similar to views observed by a person standing on a ground and looking at the different directions on the horizon), and a control based on the inclination angle from the zenith (e.g., similar to an angle from a direction pointing up towards the sky which is perpendicular to the ground).

According to example embodiments herein, example objects included in a 3-D implementation may be coordinate transformed and positioned in a 3-D space, and may be projected to a 2-D screen that accommodates the example viewport.

For example, a mouse may be used to manipulate the 3-D map control, similar to controls used for 3-D games. For example, a default view of a building may be displayed in 3-D space. For example, a current view may include a view of the building, based on a perspective of a view at a particular distance from the building (e.g., based on a radial distance). For example, a control based on zooming in and zooming out may be used to control the viewing distance. For example, in order to control the azimuth or inclination, the user may point the mouse at the map, holding the right mouse button, and move the mouse sideways (from the perspective of the user) for controlling azimuth. For example, the mouse may be moved back and forth to control inclination angle.

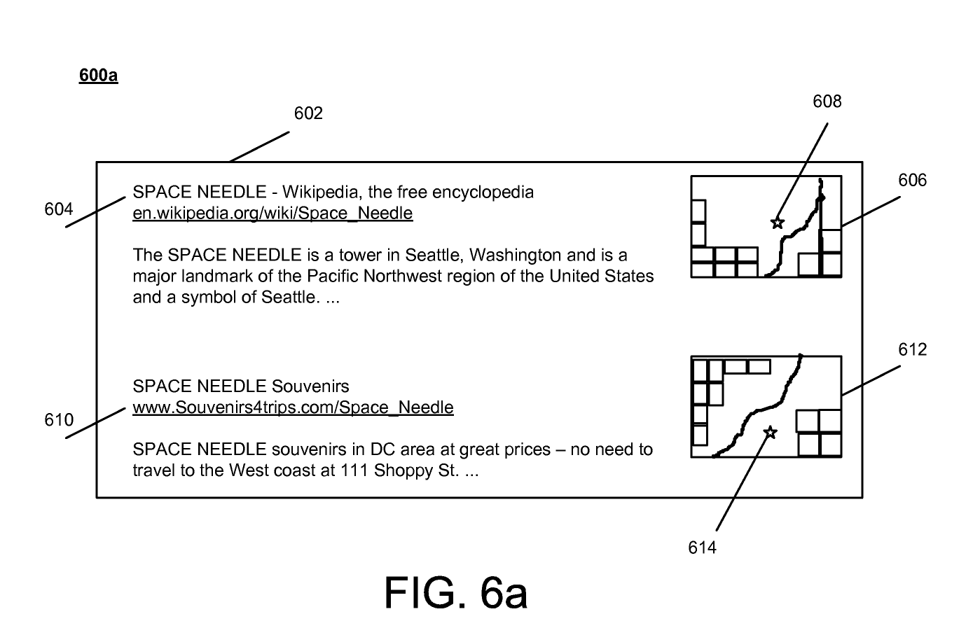

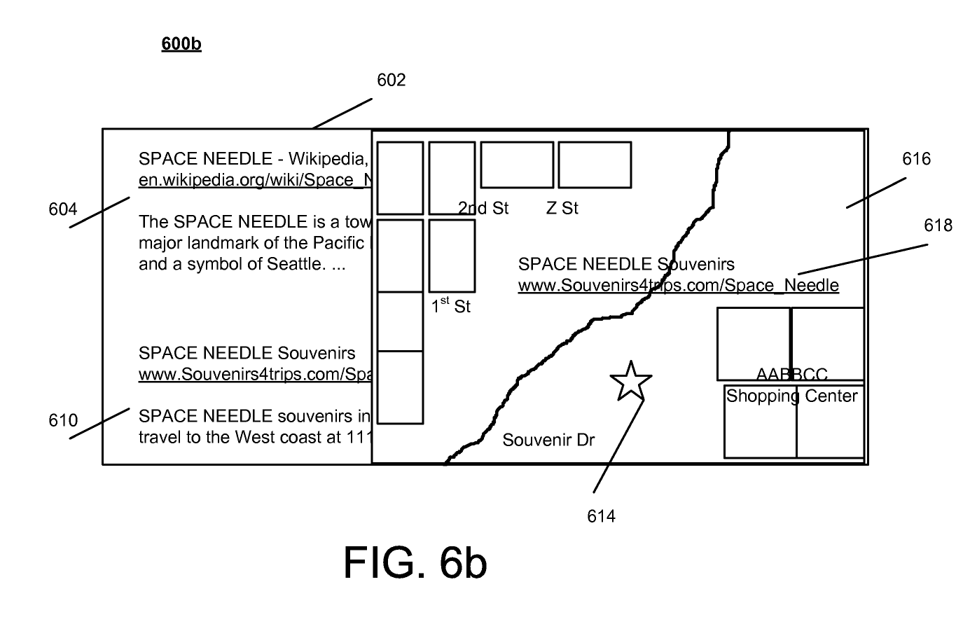

FIG. 6 depicts example user device displays of search results with maps, in accordance with example embodiments discussed herein. As shown in FIG. 6a, a search results display area 602 may include a plurality of search results with corresponding selectable thumbnail maps. For example, a first search result 604 (e.g., a query response 106) may be displayed adjacent to a selectable thumbnail map 606 that is associated with the first search result 604. According to an example embodiment, the selectable thumbnail map 606 may include a graphical focus icon 608 (e.g., a graphical geographic focus entity 138) indicating a geographic location associated with the corresponding search result 604. For example, the graphical focus icon 608 indicates a geographic location associated with the corresponding search result 604 for a WIKIPEDIA web page discussing the “SPACE NEEDLE” in Seattle. For example, the location information of the “SPACE NEEDLE” may be included with the WIKIPEDIA web page for retrieval with search results, and may be used in determining the selectable thumbnail map 606.

Similarly, a search result 610 may be displayed adjacent to a selectable thumbnail map 612 that is associated with the search result 610. According to an example embodiment, the selectable thumbnail map 612 may include a graphical focus icon 614 (e.g., a graphical geographic focus entity 138) indicating a geographic location associated with the corresponding search result 610. For example, the graphical focus icon 614 indicates a geographic location associated with the corresponding search result 610 for a web page discussing a business entity offering “SPACE NEEDLE souvenirs” in the District of Columbia area. For example, an address included in the web page (e.g., “111 Shoppy St.”) may be used in determining the selectable thumbnail map 606.

As shown in FIG. 6b, an expanded map 616 may be displayed in response to a user selection of the selectable thumbnail map 612 shown in FIG. 6a. As shown in FIG. 6b, the expanded map 616 may include a selectable link 618, and an expanded graphical focus icon 614 indicating a geographic location associated with the corresponding search result 610 (e.g., the business entity offering the souvenirs). According to an example embodiment, when the user selects the selectable thumbnail map 612 (e.g., via a click or touch on the thumbnail map), the expanded map 616 may appear on the same page which may be displayed at a different layer. According to example embodiments, the expanded map 616 may be movable or immobile. According to example embodiments, the expanded map 616 may be closed, and/or may include a link (e.g., link 618) to a corresponding URL which may allow page jumps. According to an example embodiment, the expanded map 616 may include map control (e.g., map navigation, zoom controls).

Example techniques discussed herein may provide query responses 106 (e.g., web search results) that may each be displayed adjacent to corresponding selectable thumbnail maps 136 that each include a single graphical focus entity 138. Example techniques discussed herein may provide an expanded map 148 in response to a user selection of one of the selectable thumbnail maps 136, such that the expanded map 148 may be displayed in a same window (e.g., at a different layer) with at least a portion of the query responses 106 that includes the query response 106 corresponding to the selected thumbnail map 136. The expanded map 148 may include a selectable link 150 that is associated with the query result 106 corresponding to the selected thumbnail map 136. Thus, a user may view both thumbnail maps 136 adjacent to corresponding query responses 106, and the expanded map 148 without navigating away from the display window providing the display of the query responses 106 and selectable thumbnail maps 136.

Customer privacy and confidentiality have been ongoing considerations in online environments for many years. Thus, example techniques for determining search results with maps for users may avoid accessing data that may be personal to particular users. Alternatively, example techniques for determining search results with maps for users may use data provided by users who have provided permission via one or more subscription agreements (e.g., “Terms of Service” (TOS) agreements) with associated applications or services associated with the selective spatial audio communications. Further, users may be provided with many different types of opportunities to opt out of allowing their identifying information to be used for statistical purposes, including specific user permissions that may be requested before collection of the information. For example, a user may be specifically requested to agree to allow their identifying information to be obtained, before the information is collected. According to an example embodiment herein, personally identifiable information from a user may not be stored in the example system 100.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a query response acquisition component that obtains a first plurality of query responses based on a first query;
a result geographic locality determination component that determines, via a device processor, corresponding result geographic localities associated with each of the first plurality of query responses;
a thumbnail map determination component that determines a corresponding selectable thumbnail map for each one of the first plurality of query responses, based on the corresponding result geographic localities, each of the corresponding selectable thumbnail maps including a graphical geographic focus entity indicating a geographic location that is associated with the corresponding one of the first plurality of query responses;
a query response transmission component that initiates transmission of query response display information associated with a display of each of the first plurality of query responses adjacent to each respective corresponding selectable thumbnail map;
an expanded map determination component that determines a first expanded map that corresponds to one of the selectable thumbnail maps, the first expanded map including a selectable link associated with the one of the first plurality of query responses that is associated with the one of the corresponding selectable thumbnail maps that represents a compressed view of the first expanded map; and
an expanded map transmission component that initiates transmission of expanded map display information associated with a display of the first expanded map, in a display area in common with a display of at least a portion of the first plurality of query responses that includes the corresponding query response, the first expanded map including the selectable link associated with the corresponding query response that is associated with the one of the corresponding selectable thumbnail maps that represents a compressed view of the first expanded map.

2. The system of claim 1, further comprising:
an expanded map acquisition component that receives a first request for the first expanded map based on a selection action associated with one of the corresponding selectable thumbnail maps, wherein:
the expanded map transmission component initiates transmission of the expanded map display information in response to the first request for the first expanded map.

3. The system of claim 1, wherein:
the query response display information includes display order information associated with an ordering of the display of each of the first plurality of query responses adjacent to each respective corresponding selectable thumbnail map, the display order information based on search engine result relevance information.

4. The system of claim 1, wherein:
the first plurality of query responses includes one or more of:
an aggregated query response that includes aggregated query response data based on a search response aggregation operation associated with a search engine,
a Uniform Resource Locator (URL) associated with a first web page representing a first one of the plurality of query responses,
a caption and a URL associated with a second web page representing a second one of the plurality of query responses, or
a web page description associated with a third web page representing a third one of the plurality of query responses.

5. The system of claim 1, further comprising:
a query information determination component that obtains first query information associated with the first query; and
a query geographic locality determination component that determines one or more query geographic localities associated with the first query, based on the first query information, wherein:
the thumbnail map determination component determines at least one of the corresponding selectable thumbnail maps based on the one or more query geographic localities associated with the first query.

6. The system of claim 5, wherein:
the first query information includes one or more of:
a street address,
an indication of a geographic location,
a geographic location indication associated with a user device that is associated with a transmission of the first query,
an indication of a landmark, or
a name of an item.

7. The system of claim 1, further comprising:
a response information determination component that obtains corresponding query response information associated with each one of the first plurality of query responses, wherein:
the thumbnail map determination component determines at least one of the corresponding selectable thumbnail maps based on the corresponding query response information associated with at least one of the first plurality of query responses.

8. The system of claim 7, wherein:
the corresponding query response information includes one or more of:
geographic location information included in a query response web page,
geographic location information included in web page metadata associated with a query response web page,
a street address,
an indication of a geographic location,
an indication of a landmark, or
a name of an item.

9. A method comprising:
obtaining first query information associated with a first query;
obtaining a first plurality of query responses based on the first query;
determining a response geographic locality associated with each of the first plurality of query responses;
obtaining a corresponding selectable thumbnail map for each one of the first plurality of query responses, each of the corresponding selectable thumbnail maps including a graphical geographic focus entity that is associated with each one of the first plurality of query responses;
initiating a transmission of query response display information associated with a display of each of the first plurality of query responses adjacent to each respective corresponding selectable thumbnail map;
receiving a first request for a first expanded map based on a selection action associated with one of the corresponding selectable thumbnail maps; and
initiating transmission of expanded map display information associated with a display of the first expanded map, on a page in common with display of the corresponding query response, the first expanded map including a selectable link associated with the corresponding query response that is associated with the one of the corresponding selectable thumbnail maps that represents a compressed view of the first expanded map.

10. The method of claim 9, wherein:
receiving the first request for the first expanded map includes receiving the first request for the first expanded map based on a user selection of the one of the corresponding selectable thumbnail maps.

11. The method of claim 9, wherein:
obtaining the first plurality of query responses includes receiving the first plurality of query responses from a search engine, based on a web search operation of the search engine, based on the first query.

12. The method of claim 11, wherein:
at least one of the first plurality of query responses is based on search engine retrieval information associated with one or more of:
a blog entry,
a WIKIPEDIA entry,
a social network entry,
a yellow pages entry,
a business entity web page,
a personal entity web page,
an organization web page, or
a government entity web page.

13. The method of claim 9, wherein:
the selectable link associated with the corresponding query response includes a URL included in the corresponding query response.

14. The method of claim 13, wherein:
the first expanded map includes the graphical geographic focus entity in an expanded display format, the selectable link and a caption associated with the corresponding query response.

15. A computer program product tangibly embodied on a computer-readable storage medium and including executable code that causes at least one data processing apparatus to:
obtain a first plurality of query responses based on a first query;
determine a corresponding selectable thumbnail map for each one of the first plurality of query responses, each of the corresponding selectable thumbnail maps including a graphical geographic focus entity that is associated with the corresponding one of the first plurality of query responses;
initiate a display of the first plurality of query responses with the corresponding selectable thumbnail maps each displayed adjacent to the corresponding one of the first plurality of query responses, in response to the first query;
receive a first request for a first expanded map based on a selection action associated with one of the corresponding selectable thumbnail maps; and
initiate a display of the first expanded map that includes a selectable link associated with the corresponding one of the first plurality of query responses that is associated with the one of the corresponding selectable thumbnail maps that represents a compressed view of the first expanded map, the first expanded map displayed in a common display area with the display of the first plurality of query responses with the corresponding selectable thumbnail maps.

16. The computer program product of claim 15, wherein the executable code causes at least one data processing apparatus to:
determine a result geographic locality associated with each of the first plurality of query responses, wherein:
determining the corresponding selectable thumbnail map for each one of the first plurality of query responses includes determining the corresponding selectable thumbnail map for each one of the first plurality of query responses based on the determined result geographic locality associated with each of the first plurality of query responses.

17. The computer program product of claim 15, wherein the executable code causes at least one data processing apparatus to:
obtain first query information associated with the first query; and
determine a query geographic locality associated with the first query, based on the first query information, wherein:
at least one of the corresponding selectable thumbnail maps is determined based on the query geographic locality associated with the first query.

18. The computer program product of claim 15, wherein the executable code causes at least one data processing apparatus to:
initiate the display of the first plurality of query responses with the corresponding selectable thumbnail maps each displayed adjacent to the corresponding one of the first plurality of query responses, in response to the first query, based on display order information associated with an ordering of display of each of the first plurality of query responses adjacent to each respective corresponding selectable thumbnail map, the display order information based on search engine result relevance information.

19. The computer program product of claim 15, wherein the executable code causes at least one data processing apparatus to:
initiate the display of the first plurality of query responses with the corresponding selectable thumbnail maps each displayed adjacent to the corresponding one of the first plurality of query responses, in response to the first query, within a scrollable display area on a mobile device.

20. The computer program product of claim 19, wherein the executable code causes at least one data processing apparatus to:
initiate the display of the first expanded map in the common display area with the display of the first plurality of query responses with the corresponding selectable thumbnail maps, within the scrollable display area on the mobile device.
